(19) United States
(12) Patent Application Publication
(10) Pub. No.: US 2022/0412385 A1
(43) Pub. Date: Dec. 29, 2022

(54) PIPE CONNECTION STRUCTURE AND FURNITURE KIT

(71) Applicant: VITRA AG, Birsfelden (CH)

(72) Inventors: Stefan KELLER, Steinen - Hofen (DE); Helmut SCHÜTT, Mülllheim - Hügelheim (DE)

(21) Appl. No.: 17/779,460

(22) PCT Filed: Nov. 25, 2020
(86) PCT No.: PCT/EP2020/083382

§ 371 Date: May 24, 2022

(30) Foreign Application Priority Data
Nov. 25, 2019 (CH) 01487/19

(51) Int. Cl. F16B 7/04

(52) U.S. Cl. CPC F16B 7/04

(57) ABSTRACT

The invention relates to a pipe connection structure comprising a first component (2) and a second component (5). The first component (2) has a pipe portion (21) and the second component (5) is equipped with a pipe portion (51) and a pipe connector (7) which extends from a longitudinal end of the pipe portion (51) and can be arranged in the pipe portion (21) of the first component (2). The pipe portion (21) of the first component (2) and the pipe portion (51) of the second component (5) lie axially against each other when the pipe connector (7) of the second component (5) is arranged in the pipe portion (21) of the first component (2). The pipe connector (7) of the second component (5) is equipped with an actuatable locking clamping mechanism, which locking clamping mechanism of the pipe connector (7) of the second component (5) is designed to lock and clamp the pipe portion (21) of the first component (2) and the pipe portion (51) of the second component (5) together when the locking clamping mechanism is actuated while the pipe connector (7) of the second component (5) is arranged in the pipe portion (21) of the first component (2).

### TECHNICAL FIELD

The invention relates to a pipe connection structure as disclosed herein and a furniture kit having such a pipe connection structure.

Such pipe connection structures, which have a first component having a pipe portion and a second component having a pipe portion that comprises a pipe connector which extends from a longitudinal end of the pipe portion and can be arranged in the pipe portion of the first component, the pipe portion of the first component and the pipe portion of the second component lying axially against each other when the pipe connector of the second component is arranged in the pipe portion of the first component, can be used to construct pipe structures such as scaffolding or furniture such as frames and the like.

### BACKGROUND

In order to connect pipes or components having pipes, it is known that pipes are inserted into one another. For this purpose, at least one of the pipes is typically equipped with a pipe connector which can be inserted into the other pipe. Often, the pipe connector is smaller in diameter than the rest of the pipe, so that it can be inserted into the other pipe. For example, it is known to form an end portion of the pipe so as to be tapered or have a reduced outer circumference, so that it can be inserted into the other pipe. The pipes usually lie against each other when the pipe connector is inserted into the other pipe.

In the case of such pipes or components having pipes, pipe structures can be variably constructed, dismantled again or also converted in a simple manner.

If pipe structures are intended to be able to withstand certain loads, inserted pipe connections often reach their limits. For example, it can be disadvantageous that the pipes are not connected in the axial direction, as a result of which handling of the entire pipe structure can be cumbersome. For example, it can be difficult to relocate the pipe structure as a whole.

In addition, inserted pipe connections of the type described above typically have some play. This is because the pipe connectors should be easy to insert into the pipes and are therefore somewhat undersized. In addition, for reasons of efficiency, pipes are often manufactured with manufacturing tolerances which do not allow for a precisely fitting insertion connection. Correspondingly, inserted pipe structures are usually comparatively unstable or rickety. In particular when the pipe structures are subjected to relatively high loads, simple insertion connections are usually not enough to ensure sufficient stability. For example, in furniture manufacture, such as in the construction of frames, conventional pipe structures connected by insertion are usually not stable enough or would be too expensive to produce if they were to be manufactured precisely enough for precisely-fitting insertion.

The problem addressed by the present invention is therefore that of proposing a system by means of which tubular components or components having pipe portions can be connected to one another in an efficient, precise and stable manner.

### SUMMARY OF THE INVENTION

According to the invention, the problem is solved by a pipe connection structure and by a furniture kit as described herein. Advantageous embodiments of the invention can be found in the dependent claims.

The essence of the invention is as follows: A pipe connection structure comprises a first component having a pipe portion and a second component having a pipe portion and a pipe connector which extends from a longitudinal end of the pipe portion and can be arranged in the pipe portion of the first component. The pipe portion of the first component and the pipe portion of the second component are designed such that they lie axially against each other when the pipe connector of the second component is arranged in the pipe portion of the first component. The pipe connector of the second component is equipped with an actuatable locking clamping mechanism. The locking clamping mechanism of the pipe connector of the second component is designed to lock and clamp the pipe portion of the first component and the pipe portion of the second component together when the locking clamping mechanism is actuated while the pipe connector of the second component is arranged in the pipe portion of the first component.

In the context of the invention, the term “pipe portion” refers to a tubular part or region of the component. The pipe portion can be designed, for example, as a round pipe or as a polygonal pipe such as a square pipe. The pipe portion is hollow on the inside, as is usual in the case of tubular structures such as pipes.

The pipe portions are typically straight and elongate. They can define a substantially constant cross section transverse to the longitudinal axes thereof. In the case of a round pipe, this cross section is usually circular or annular, and in the case of a square pipe, it is square or rectangular.

The components can be made of metal, such as steel or aluminum. Alternatively, they can also consist of a plastics material or a natural product such as wood.

The components can be individual pipes, which mainly consist of the pipe portion. In many applications, such as in furniture manufacture, the components can have other elements or structures in addition to the pipe portions. For example, the components can each be designed in a ladder-like manner with two parallel vertical supports as pipe portions which are connected to one another via parallel rungs. The first and second components can have identical or also different designs.

The outer dimensions of the pipe connector can be designed such that it can be inserted into the pipe portion of the first component. In this way, the first component can be attached to the second component.

The locking clamping mechanism can be implemented as a mechanism in the pipe connector. For this purpose, as explained in more detail below in a preferred embodiment, said locking clamping mechanism can comprise moving parts and static parts. The locking clamping mechanism, as a whole, can also constitute the pipe connector.

In the case of comparatively large components having a plurality of pipe portions, the second component can have a plurality of locking clamping mechanisms. In particular, one locking clamping mechanism can be provided for each pipe connector.

Within the meaning of the invention, locking can be understood to be a form-fitting connection between the two pipe portions of the first and second component. In this case, a form fit can in particular be present in such a way that an element of the locking clamping mechanism blocks the pipe portion of the first component in the axial direction and thus prevents the pipe portion of the first component from being removed from the pipe portion of the second component.

Within the meaning of the invention, clamping can be understood to mean a connection under pressure or tension which presses or clamps the pipe portion of the first component and the pipe portion of the second component against one another such that they have substantially no play with respect to one another. In the case of a clamped connection, the pipe portions can effectively be handled as one piece.

Due to the provision of the locking clamping mechanism, the two components can be connected to one another in an extremely robust and secure manner. In particular, as a result of the locking, the connection between the two pipe portions can be provided in a secure and quasi non-releasable manner. As a result of the clamping, the connection between the two pipe portions can also be such that said portions can be effectively handled as one piece. This reduces or completely prevents wobbling of the pipe portions relative to one another when the pipe portions are in the locked state. The pipe connection structure according to the invention thus makes it possible to connect tubular components or components having pipe portions to one another in an efficient, precise and stable manner.

Preferably, the pipe portion of the first component is equipped with a lug opening, the locking clamping mechanism of the pipe connector has a lug, and the locking clamping mechanism of the pipe connector of the second component is designed such that the lug is moved into the lug opening of the pipe portion of the first component and the pipe portion of the first component is locked to the pipe portion of the second component when the locking clamping mechanism of the pipe connector of the second component is actuated while the pipe connector of the second component is arranged in the pipe portion of the first component.

The lug opening in the pipe portion of the first component can be provided as a bore in the pipe wall. The lug moving into the lug opening and remaining there while the two pipe portions are locked can efficiently produce a form fit or a form fit-like connection. As a result, the two pipe portions can be securely blocked and locked together.

The locking clamping mechanism of the pipe connector of the second component is preferably designed such that the lug is pressed against an edge of the lug opening of the pipe portion of the first component and clamps the pipe portion of the first component to the pipe portion of the second component when the locking clamping mechanism of the pipe connector of the second component is actuated while the pipe connector of the second component is arranged in the pipe portion of the first component.

In this way, the lug can in particular press the pipe portion of the second component axially against the pipe portion of the first component, such that the two pipe portions are clamped against one another. This allows the two pipe portions or the two components to be connected to one another such that they can effectively be handled as a single part. In addition, the two components can thus ensure a very high level of stability.

The locking clamping mechanism of the pipe connector of the second component is preferably designed such that when the locking clamping mechanism is actuated while the pipe connector of the second component is arranged in the pipe portion of the first component, the lug is first moved into the lug opening of the pipe portion of the first component in order to lock the pipe portion of the first component to the pipe portion of the second component, and the lug of the locking clamping mechanism of the pipe connector of the second component is subsequently pressed against the edge of the lug opening of the pipe portion of the first component in order to clamp the pipe portion of the first component to the pipe portion of the second component. In this way, the two functions of the locking clamping mechanism can be carried out one after the other in a temporally separated manner or also in a partially temporally overlapping manner when the locking clamping mechanism is actuated, which makes a highly adapted locking and tensioning possible. In particular, the locking can remain in place during clamping.

The locking clamping mechanism of the pipe connector of the second component is preferably designed such that the lug can be moved quasi-radially in order to lock the pipe portion of the first component to the pipe portion of the second component. In this context, the term “radially” can relate to the associated pipe portion. In the case of a circular pipe cross section, radially in the narrower sense can therefore mean along the radius or in the direction of the radius. For other cross sections, radially may refer to away from the axis of the associated pipe portion. In this case, the radial movement can be a movement perpendicular to the longitudinal axis of the pipe portion. In this context, the term “radially movable” does not refer to an exclusively radial movement, but can in particular also include a mixed axial and radial movement. It is also sufficient for the movement of the lug to include a radial component.

The radial movement of the lug allows it to be moved into the lug opening in a simple and efficient manner. In particular, this also allows a simple design of the lug opening, for example as a bore in the pipe wall.

In this case, the locking clamping mechanism of the pipe connector of the second component preferably comprises a base which is fixedly connected to the pipe portion of the second component, and an actuator which is pivotably mounted on the base and on which the lug is formed. In this way, the lug can be efficiently pivoted outward, such that it performs a radial movement.

The locking clamping mechanism of the pipe connector of the second component is preferably designed such that the lug can be moved quasi-axially in order to clamp the pipe portion of the first component to the pipe portion of the second component. In this way, the lug can be efficiently pressed against the edge of the lug opening, which efficiently clamps the two pipe portions together.

The actuator of the locking clamping mechanism of the pipe connector of the second component is preferably axially movably mounted on the base of the pipe connector of the second component. In this way, the actuator can induce both radial and axial movement of the lug. In particular, the actuator can initiate a mixed movement of the lug that includes a radial and an axial component.

In this case, the actuator of the locking clamping mechanism of the pipe connector of the second component preferably has an elongate bolt receptacle, and the base of the pipe connector of the second component preferably has a bolt which protrudes into the bolt receptacle. In order to pivot the actuator, said bolt receptacle can be rotated about the bolt. Bolts and bolt receptacles thus form a joint. At the same time, the elongate shape of the bolt receptacle allows the actuator to also be moved axially. In this way, a mixed movement can be generated, which induces a radial and an axial movement of the lug.

The locking clamping mechanism of the pipe connector of the second component preferably comprises an actuating screw which is coupled to the lug of the locking clamping mechanism of the pipe connector of the second component such that the lug moves when the actuating screw is rotated. Such an actuating screw can make efficient actuation and, in particular, a sufficiently strong clamping of the pipe portions possible.

In this case, the actuator of the locking clamping mechanism of the pipe connector of the second component preferably has a continuous screw receptacle into which the actuating screw is screwed. In this way, the screw can engage directly on the actuator and act thereon. This allows efficient translation of the movement of the screw onto the lug.

The pipe portion of the first component is preferably equipped with an actuation opening through which a screwdriver can be inserted such that it engages in the actuating screw when the pipe connector of the second component is arranged in the pipe portion of the first component. The actuation opening can be provided as a bore in the pipe wall of the pipe portion of the first component. For example, the actuation opening can be adjacent to the lug opening.

The locking clamping mechanism of the pipe connector of the second component preferably comprises a spring element which moves the locking clamping mechanism into an initial position when the locking clamping mechanism is not actuated. In the initial position, the pipe portion of the first component and the pipe portion of the second component are not locked and clamped together, even if the pipe connector of the second component is arranged in the pipe portion of the first component. The spring element can be a coil spring, a resilient element, or any other structure which can move the locking clamping mechanism into the initial position. By means of such a spring element, the locking clamping mechanism can be released again efficiently and the components can be removed from one another again. For example, the spring element can attach to the actuator or act thereon.

The pipe connection structure according to the invention and the preferred embodiments thereof can be implemented in different uses or devices. For example, the pipe connection structure can be used in scaffolding.

Another aspect of the invention relates to a furniture kit. The furniture kit comprises a set of base ladders and a set of construction ladders.

The term “furniture” in the context of the invention refers to furnishing items, primarily in interior spaces such as homes, shops, offices or other units for use. Typically, furniture is movable, as opposed to immovable objects (immovables) which are fixedly connected to the floor or to structural installations. In most cases, furniture has a predetermined purpose and is intended for a specific use. Typical furniture can be tables, chairs, shelves, racks and the like.

In this context, the term “set” refers to a plurality of elements or components. For example, the set of base ladders comprises two or more base ladders.

The base ladders each comprise two vertical supports which are connected to one another via an upper rung and a lower rung, the two vertical supports each being equipped with a foot for placement on a floor. The construction ladders each have two vertical supports which are connected to one another via an upper rung and a lower rung, the vertical supports being designed to be attached to the vertical supports of another of the construction ladders or the vertical supports of one of the base ladders. In particular, one of the base ladders and construction ladders are in each case designed as first components of a pipe connection structure as described above and the other of the base ladders and construction ladders are in each case formed as second components of the pipe connection structure.

The furniture kit can be provided so that different pieces of furniture can be flexibly constructed from the same components as required. Such furniture can be, for example, shelves, frames or tables. In particular, the furniture can be office furniture.

In addition to the upper and lower rungs, the base ladders can also comprise other rungs. Typically, the vertical supports and the rungs are substantially rod-shaped. The rungs and the vertical supports can have a substantially round or circular cross section. The vertical supports and the rungs of a base ladder can each be virtually at right angles to one another, such that the rungs extend in parallel with one another and the vertical supports extend in parallel with one another.

The vertical supports of the base ladders can be formed over long distances as rod portions such as round or polygonal pipes. They are typically made of a robust material such as metal. The vertical supports of a base ladder advantageously extend in parallel with one another.

The rungs of the base ladders can also be formed over long distances as rod profiles or pipes. Advantageously, they have a periphery having a quasi-circular cross section. During operation, the upper and lower rungs are advantageously oriented horizontally and extend in parallel with one another.

The feet of the base ladders can be designed as sliders, for example. If the furniture created from the furniture kit is intended to be moved frequently, rollers can also be used as the feet of the base ladders.

Since the base ladders and construction ladders are respectively designed as first and second components of the pipe connection structure according to the invention, they can be connected to one another efficiently and securely. In particular, the effects and advantages described above in connection with the pipe connection structure according to the invention can be used for assembling, converting and dismantling a piece of furniture. The furniture kit according to the invention thus makes it possible for furniture to be assembled in an extremely versatile and flexible manner. This can be advantageous in particular in the case of changing circumstances, as can regularly occur on sales floors or in office workplaces.

The furniture kit preferably comprises a set of elongate cross-members, which are each equipped at the longitudinal ends thereof with a snap-on claw which is designed to be mounted without tools on one of the rungs of one of the base ladders, and a set of elongate sway braces which are each equipped at the longitudinal ends thereof with a clamp which is designed to be mounted on one of the rungs of one of the base ladders by engaging around one of the rungs, the cross-members and sway braces being designed such that one of the cross-members can be mounted on the upper rung of a first of the base ladders and on the upper rung of a second of the base ladders, while one of the sway braces is mounted on the upper rung of the first of the base ladders and on the lower rung of the second of the base ladders.

The stability and functionality of the furniture constructed using the furniture kit can be guaranteed by means of such cross-members and sway braces without having to make any significant restrictions in terms of flexibility.

### BRIEF DESCRIPTION OF THE DRAWINGS

Further advantageous embodiments of the invention can be found in the following description of embodiments of the invention with the aid of the schematic drawings. In particular, the pipe connection structure according to the invention and the furniture kit according to the invention are described in more detail below with reference to the accompanying drawings on the basis of embodiments.

FIG. 1 is a front view of a base ladder of an embodiment of a furniture kit according to the invention, in which an embodiment of a pipe connection structure according to the invention is implemented.

FIG. 2 is a front view of a construction ladder of the furniture kit of FIG. 1 with a pipe connector of the pipe connection structure of FIG. 1.

FIG. 3 is a top view of a cross-member of the furniture kit of FIG. 1.

FIG. 4 is a side view of a snap-on claw of the cross-member of FIG. 3.

FIG. 5 is a front view of a sway brace of the furniture kit of FIG. 1.

FIG. 6 is a top view of the sway brace of FIG. 5.

FIG. 7 is a perspective view of a clamp of the sway brace of FIG. 5.

FIG. 8 is a perspective view of a frame structure constructed from the furniture kit of FIG. 1.

FIG. 9 is a cross-sectional view of the pipe connection structure of the furniture kit of FIG. 1, as implemented in the frame structure of FIG. 8, in a released state.

FIG. 10 is a cross-sectional view of the pipe connection structure of FIG. 9 in a locked state.

FIG. 11 is a cross-sectional view of the pipe connection structure of FIG. 9 in a locked and clamped state.

### DETAILED DESCRIPTION OF EMBODIMENTS OF THE INVENTION

Certain terms are used in the following description for practical reasons and are not intended to be limiting. The words “right,” “left,” “down” and “up” indicate directions in the drawing to which reference is made. The terms “inward,” “outward,” “below,” “above,” “left,” “right” or the like are used to describe the arrangement of designated parts relative to one another, the movement of designated parts relative to one another and the directions toward or away from the geometric center of the invention and stated parts thereof as shown in the drawings. This spatial relative information also includes different positions and orientations than those shown in the drawings. For example, if a part shown in the drawings is turned over, elements or features that are described as “below” are then “above.” The terminology includes the words expressly mentioned above, derivatives of same, and words of similar meaning.

In order to avoid repetitions in the drawings and the associated description of the different aspects and embodiments, certain features are to be understood as common for different aspects and embodiments. The omission of an aspect in the description or a figure does not suggest that this aspect is missing in the associated embodiment. Rather, such an omission can be used for clarity and to prevent repetitions. In this context, the following statement applies to the entire further description: If reference signs are included in a figure for the sake of clarity in the drawing, but are not mentioned in the directly associated description text, reference is made to the explanation thereof in the preceding description of the drawings. If reference signs are also mentioned in the description text belonging directly to a figure, which are not included in the associated figure, reference is made to the preceding and following figures. Similar reference signs in two or more figures represent similar or identical elements.

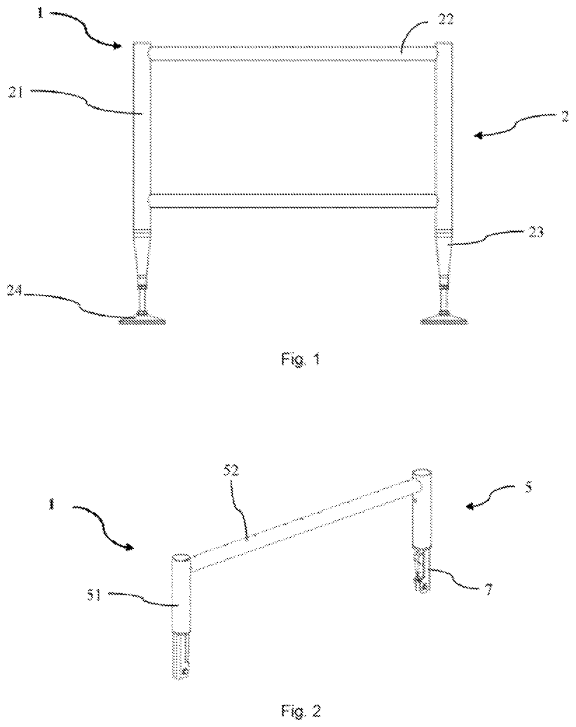

FIG. 1 shows a base ladder 2 of a set of base ladders 2 of an embodiment of a furniture kit 1 according to the invention. The base ladder 2 is designed as the first component of an embodiment of a pipe connection structure according to the invention. The base ladder consists of two parallel vertical supports 21 which are connected to one another by two horizontal rungs 22. The rungs 22 are designed as straight pipes having a circular cross section. Said rungs are at right angles to the vertical supports 21 and are fixedly connected, for example welded, thereto. The vertical supports 21 are also largely designed as straight pipes having a circular cross section and each extend downward into a tapering foot 23. The two feet 23 are each equipped with a slider 24 which is arranged on the floor for placement of the base ladder 2.

FIG. 2 shows a single-rung construction ladder 5 of a set of construction ladders 5 of the furniture kit 1. The construction ladder 5 is designed as a second component of an embodiment of a pipe connection structure according to the invention. Said construction ladder comprises two tubular vertical supports 51 which are fixedly connected to one another via a tubular rung 52. Together, the vertical supports 51 and the rung 52 are quasi U-shaped. The rungs 52 of the construction ladder have the same dimensions as the rungs 22 of the base ladder 2 of FIG. 1, such that the construction ladder 5 fits the base ladder 2.

A pipe connector 7 of the pipe connection structure extends vertically downward from the lower ends of the vertical supports 51 of the construction ladder 5 in each case. The pipe connecters 7 are designed such that they can be inserted into the vertical supports 21 of the base ladder 2 or into vertical supports 51 of a further construction ladder 5, and fix the connected vertical supports 21, 51 to one another by actuation.

In addition to the construction ladder 5, as shown in FIG. 2, the set of construction ladders 5 of the furniture kit 1 comprises further construction ladders having vertical supports connected via two parallel rungs. In comparison with the single-rung embodiment of FIG. 2, these construction ladders are designed to be longer or taller.

FIG. 3 shows a cross-member 3 of a set of cross-members 3 of the furniture kit 1. The cross-member 3 is formed from an elongate rod portion 31 and snap-on claws 32 which each extend outward to the left and to the right from the longitudinal ends of the rod portion. The rod portion 31 is formed from a pipe having a circular diameter which corresponds to the diameter of the rungs 52 of the construction ladder 5 and the rungs 22 of the base ladder 2. On the upper face, the rod portion 31 is in each case equipped with a bore 311 as a female plug-in part close to the longitudinal ends thereof.

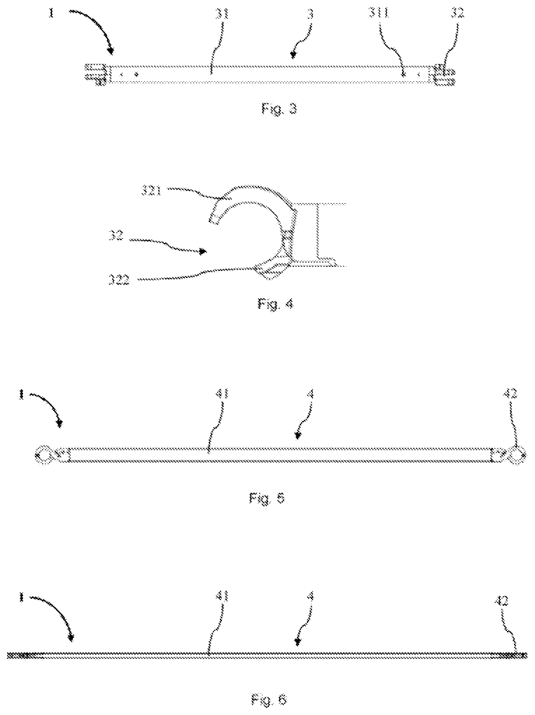

In FIG. 4, the left-hand claw of the two snap-on claws 32 of the cross-member 3 of FIG. 3 is shown enlarged. It can be seen that the snap-on claw 32 has an upper rung receptacle 321 formed correspondingly to the rungs 22, 52 of the base ladders and construction ladders 2, 5 and a lower slider 322. The snap-on claw 32 is equipped with a spring which pushes the slider 322 to the left in the position shown in FIG. 4. In this position, the snap-on claw 32 is engaged on a rung 22, 52 or a rod portion 31 of another cross-member 3 when the rung receptacle 321 receives same. The cross-member 3 is then mounted on the rung 22, 52 or the rod portion 31.

In order to release the snap-on claw 32, the slider 322 is pushed to the right, for example manually, counter to the spring force. As a result, the snap-on claw 32 is opened and the cross-member 3 can be removed. In order to mount the cross-member 3 on a rung 22, 52 or on a rod portion 31 of another cross-member 3, the snap-on claw 32 is pressed onto the rung 22, 52 or the rod portion 31 from above. Due to the slanted lower face of the slider 322, which is designed as an actuating surface, the slider is pushed to the right, such that the rung receptacle 321 can receive the rung 22, 52 or the rod portion 31. The slider 322, driven by the spring, then snaps back in below the rung 22, 52 or the rod portion 31, such that a secure fastening is achieved.

FIG. 5 shows a sway brace 4 of a set of sway braces 4 of the furniture kit 1. The sway brace 4 has a rod portion 41 which transitions into a clamp 42 at each of the longitudinal ends thereof. As can be seen together with FIG. 6, the rod portion 41 is designed as a solid square rod having a rectangular cross section. Due to the solid design, the sway brace can be particularly robust and designed to absorb comparatively large forces.

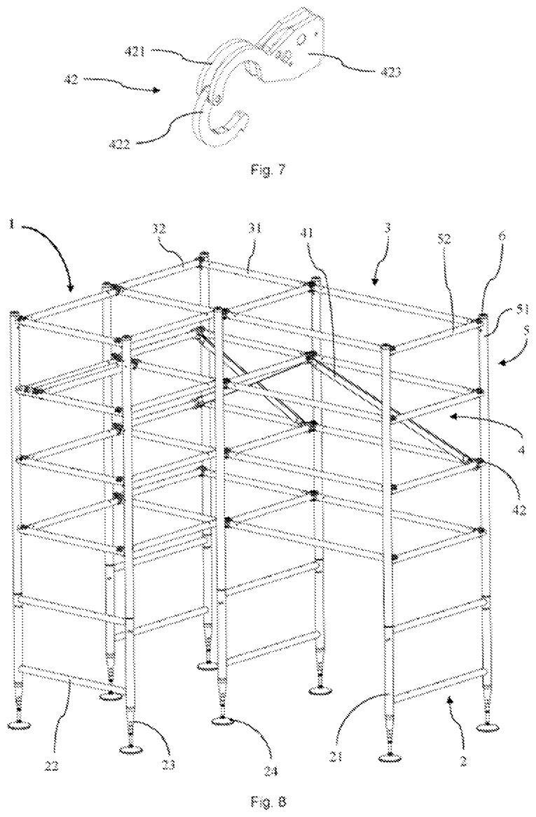

FIG. 7 shows one of the clamps 42 of the sway brace 4 in an open position. The clamp 42 is equipped with a base 423, an upper clasping part 421 and a lower upper clasping part 422 in a handcuff-like manner. The lower clasping part 422 is pivotably mounted on the upper clasping part 421 via a hinge joint. A latch is arranged in the base 423 that fixes the lower clasping part 422 when the clamp 42 is closed such that it engages around a rung 22, 52. In particular, the lower clasping part 422 is equipped with a latching lug which engages behind a spring-loaded bolt of the locking mechanism. The rung 22, 52 is thus securely held and a release of the clamp 42 without actuation of the latch can be prevented.

FIG. 8 shows a frame structure constructed from the furniture kit 1 as a three-dimensional supporting pipe structure. The frame structure comprises four ladders which are each formed from a base ladder 2 and two construction ladders 5 attached vertically thereto which each have two rungs 52. The rungs 52 of the construction ladders 5, which are at the same height, are each connected to one another via two cross-members 3. For this purpose, the snap-on claws 32 of the cross-members 3 are mounted on the rungs 52 so as to be adjacent to the vertical supports 51 of the construction ladders 5. At the same time, a plurality of sway braces 4 are connected diagonally or obliquely to rungs 52 at two different heights.

As a result of the provision of the cross-members 3 together with the sway braces 4 on the ladders, the frame structure is extremely robust and rigid. In particular, the frame structure can absorb comparatively large loads in this way. The upper ends of the pipe portions 51 of the uppermost construction ladders 5 are covered by covers 6 and closed.

FIG. 9 shows a detailed cross-sectional view of the pipe connection structure according to the invention in a released state or initial state, in which the pipe connector 7 can be freely axially inserted into a pipe portion of a first component, such as into one of the vertical supports 21 of the base ladder 2, as in the present case, and can be axially removed again therefrom. The base ladder 2 and the construction ladder 5 are thus loosely connected to one another.

The pipe connector 7 comprises an elongate base 72, which is fixedly connected to the vertical support 51 of the construction ladder 5, and an actuator 71 which is movable thereon to a certain extent and in a defined manner. The actuator 71 extends along the base 72 and has a lug 711 which extends radially to the right near the upper end of the actuator, a quasi-oval bolt receptacle 712 near the lower end of the actuator, and a continuous screw receptacle 713 between the lug 711 and the bolt receptacle 712. The lug 711 forms a horizontal upper stop surface in the released state.

The actuator 71 is mounted on the base 72 by a cylindrical bolt 73, which is fixedly connected to the base, extending through the bolt receptacle 712 of the actuator 71. In the released state, the bolt 73 rests against a right-hand end of the bolt receptacle 712. An actuating screw 74, which has a head having a female hexagon socket, is arranged in the screw receptacle 713. The screw receptacle 713 is equipped with an internal thread which corresponds to an external thread of the actuating screw 74.

A compression spring 75 is arranged at a height between the bolt 73 and the actuating screw 74. The compression spring 75 is attached to the base 72 and the actuator 71 so as to push the actuator 71 into the released state. This ensures that the pipe connection structure is reliably located in the released state or in the initial state without being actuated.

As can be seen in FIG. 9, the pipe connector 7 which is fastened to the vertical support 51 of the construction ladder is inserted into the vertical support 21 of the base ladder 2. The vertical support 21 of the base ladder 2 is equipped with an upper elongate lug opening 211 and a lower actuation opening 212 designed as a circular bore. The lug opening 211 is surrounded by the rung 22 of the base ladder 2, such that it is not visible from the outside. The lug 711 is level with and adjacent to the lug opening 211. The actuating screw 74 is level with the actuation opening 212, such that said screw can be accessed through the actuation opening 212 by a hexagonal screwdriver.

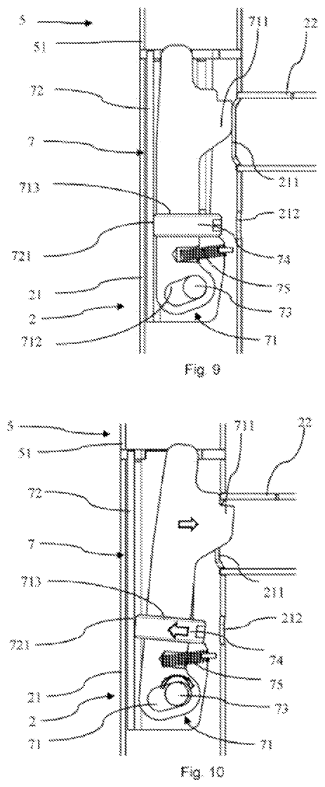

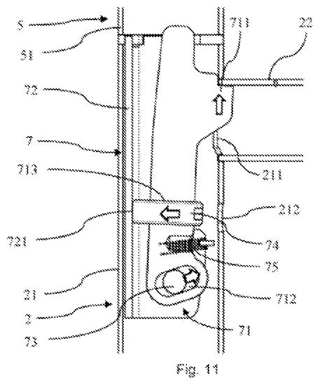

In FIG. 10 the pipe connection structure is shown during the actuation thereof. For this purpose, the actuating screw 74 is screwed into the screw receptacle 713 of the actuator 71 using the hexagonal screwdriver (not shown in FIG. 10). As indicated by the arrow on the actuating screw 74 in FIG. 10, the actuating screw 74 is thus moved quasi to the left through the screw receptacle 713. In this case, the actuating screw presses against a vertical stop surface 721 of the base 72 and pushes the actuator 71 away from the stop surface 721. This rotates the actuator 71 clockwise about the bolt 73 relative to the base 72. The spring 75 pushes the lower part of the actuator 71 to the left, such that the bolt 73 continues to rest against the right-hand end of the bolt receptacle 712.

As a result of the actuator 71 turning clockwise about the bolt 73, the lug 711 is moved quasi radially to the right. In this case, the lug 711 is moved into the lug opening 211, such that the construction ladder 5 and the base ladder 2 are locked to one another. In particular, the lug 711 blocks an axial movement of the vertical support 21 of the base ladder 2 and the vertical support 51 of the construction ladder 5 relative to one another, such that there is a form fit between the two vertical supports 21, 51. The pipe connection structure is in a locked state in FIG. 10, in which it is not possible to separate the vertical supports 21, 51 from one another, but there is still play between the two vertical supports 21, 51 to a certain extent. In particular, an axial movement between the two vertical supports 21, 51 is still possible to a limited extent.

FIG. 11 shows the pipe connection structure after the actuation thereof in a locked and clamped state or in a final state. It can be seen that, starting from the locked state of FIG. 10, the actuating screw 74 is screwed further into the screw receptacle 713 of the actuator 71 by means of the hexagonal screwdriver (not shown in FIG. 11), and is thus moved to the left. In this case, the actuating screw presses further against the vertical stop surface 721 of the base 72 and pushes the actuator 71 away from the stop surface 721. In particular, the actuator 71 is thus moved along the bolt receptacle 712 counter to the spring force of the compression spring 75, such that the bolt receptacle 712 is moved to the right relative to the bolt 73. Since the bolt receptacle 712 is designed to be inclined or oblique in the longitudinal extension thereof, the actuator 71 is moved axially upward relative to the base 72, in the direction of the vertical support 51 of the construction ladder 5.

As indicated in FIG. 11 by the arrow shown on the lug 711 of the actuator 71, during this movement of the actuator 71 the lug 711 is moved quasi-axially upward until it strikes and presses against the upper edge of the lug opening 211 of the vertical support 21 of the base ladder 2. As a result, the vertical support 21 of the base ladder 2 is pressed against the vertical support 51 of the construction ladder 5, and the two vertical supports 21, 51 are clamped together. In particular, there is no longer any play between the two vertical supports 21, 51.

Although the invention is illustrated and described in detail by means of the drawings and the associated description, this illustration and this detailed description are to be understood as illustrative and exemplary and not as limiting the invention. To avoid obscuring the invention, well-known structures and techniques may not be shown and described in detail in certain cases. It is understood that those skilled in the art can make changes and modifications without departing from the scope of the following claims. In particular, the present invention covers further embodiments with any combinations of features that may differ from the combinations of features explicitly described.

The present disclosure also includes embodiments with any combination of features mentioned or shown above or below in various embodiments. It also includes individual features in the drawings, even if they are shown there in connection with other features and/or are not mentioned above or below. The alternatives of embodiments described in the drawings and the description and individual alternatives of the features thereof can be excluded from the subject matter of the invention or from the disclosed subject matter. The disclosure includes embodiments which only include the features described in the claims or in the embodiments and also those which include additional other features.

Furthermore, the term “comprise” and derivatives thereof do not exclude other elements or steps. Likewise, the indefinite article “a” or “an” and derivatives thereof do not exclude a plurality. The functions of a plurality of features listed in the claims can be performed by a unit or a step. The terms “substantially,” “approximately,” “about” and the like in connection with a property or a value in particular also define exactly the property or exactly the value. The terms “about” and “approximately” in connection with a given numerical value or numerical range can refer to a value or range which lies within 20%, within 10%, within 5% or within 2% of the stated value or range.

1. A pipe connection structure comprising:
a first component having a pipe portion; and
a second component having a pipe portion and a pipe connector which
extends from a longitudinal end of the pipe portion and can be arranged in the pipe portion of the first component,
wherein the pipe portion of the first component and the pipe portion of the second component lie axially against each other when the pipe connector of the second component is arranged in the pipe portion of the first component,
wherein the pipe connector of the second component is equipped with an actuatable locking clamping mechanism, and
wherein the locking clamping mechanism of the pipe connector of the second component is configured to lock and clamp the pipe portion of the first component and the pipe portion of the second component together when the locking clamping mechanism is actuated while the pipe connector of the second component is arranged in the pipe portion of the first component.

2. The pipe connection structure of claim 1, wherein
the pipe portion of the first component is equipped with a lug opening,
the locking clamping mechanism of the pipe connector has a lug, and
the locking clamping mechanism of the pipe connector of the second component is configured such that the lug is moved into the lug opening of the pipe portion of the first component and the pipe portion of the first component is locked to the pipe portion of the second component when the locking clamping mechanism of the pipe connector of the second component is actuated while the pipe connector of the second component is arranged in the pipe portion of the first component.

3. The pipe connection structure of claim 1, wherein the locking clamping mechanism of the pipe connector of the second component is configured such that the lug is pressed against an edge of the lug opening of the pipe portion of the first component and clamps the pipe portion of the first component to the pipe portion of the second component when the locking clamping mechanism of the pipe connector of the second component is actuated while the pipe connector of the second component is arranged in the pipe portion of the first component.

4. The pipe connection structure of claim 2, wherein the locking clamping mechanism of the pipe connector of the second component is configured such that the lug is pressed against an edge of the lug opening of the pipe portion of the first component and clamps the pipe portion of the first component to the pipe portion of the second component when the locking clamping mechanism of the pipe connector of the second component is actuated while the pipe connector of the second component is arranged in the pipe portion of the first component, wherein the locking clamping mechanism of the pipe connector of the second component is configured such that when the locking clamping mechanism is actuated while the pipe connector of the second component is arranged in the pipe portion of the first component, wherein the lug is first moved into the lug opening of the pipe portion of the first component in order to lock the pipe portion of the first component to the pipe portion of the second component, and wherein the lug of the locking clamping mechanism of the pipe connector of the second component is subsequently pressed against the edge of the lug opening of the pipe portion of the first component in order to clamp the pipe portion of the first component to the pipe portion of the second component.

5. The pipe connection structure of claim 2, wherein the locking clamping mechanism of the pipe connector of the second component is configured such that the lug can be moved quasi-radially in order to lock the pipe portion of the first component to the pipe portion of the second component.

6. The pipe connection structure of claim 5, wherein the locking clamping mechanism of the pipe connector of the second component comprises a base which is fixedly connected to the pipe portion of the second component, and an actuator which is pivotably mounted on the base and on which the lug is formed.

7. The pipe connection structure of claim 3, wherein the locking clamping mechanism of the pipe connector of the second component is configured such that the lug can be moved quasi-axially in order to clamp the pipe portion of the first component to the pipe portion of the second component.

8. The pipe connection structure of claim 6, wherein the locking clamping mechanism of the pipe connector of the second component is configured such that the lug can be moved quasi-axially in order to clamp the pipe portion of the first component to the pipe portion of the second component, and wherein the actuator of the locking clamping mechanism of the pipe connector of the second component is axially movably mounted on the base of the pipe connector of the second component.

9. The pipe connection structure of claim 8, wherein the actuator of the locking clamping mechanism of the pipe connector of the second component has an elongate bolt receptacle, and the base of the pipe connector of the second component has a bolt which protrudes into the bolt receptacle.

10. The pipe connection structure of claim 2, wherein the locking clamping mechanism of the pipe connector of the second component comprises an actuating screw which is coupled to the lug of the locking clamping mechanism of the pipe connector of the second component such that the lug moves when the actuating screw is rotated.

11. The pipe connection structure of claim 9, wherein the locking clamping mechanism of the pipe connector of the second component comprises an actuating screw which is coupled to the lug of the locking clamping mechanism of the pipe connector of the second component such that the lug moves when the actuating screw is rotated, and wherein the actuator of the locking clamping mechanism of the pipe connector of the second component has a continuous screw receptacle into which the actuating screw is screwed.

12. The pipe connection structure of claim 10, wherein the pipe portion of the first component is equipped with an actuation opening through which a screwdriver can be inserted such that it engages in the actuating screw when the pipe connector of the second component is arranged in the pipe portion of the first component.

13. The pipe connection structure of claim 1, wherein the locking clamping mechanism of the pipe connector of the second component comprises a spring element which moves the locking clamping mechanism into an initial position when the locking clamping mechanism is not actuated.

14. A furniture kit comprising:
a set of base ladders, each comprising two vertical supports connected to one another via an upper rung and a lower rung, wherein the two vertical supports are each equipped with a foot for placement on a floor;
a set of construction ladders, each of which has two vertical supports connected to one another via an upper rung, the vertical supports being configured to be attached to the vertical supports of another of the construction ladders or to the vertical supports of one of the base ladders, wherein
one of the base ladders and the construction ladders is designed as a first component of a pipe connection structure according to claim 1, and the other of the base ladders and the construction ladders is designed as a second component of the pipe connection structure.

15. The furniture kit of claim 14, comprising:
a set of elongate cross-members which are each equipped at the longitudinal ends thereof with a snap-on claw which is configured to be mounted without tools on one of the rungs of one of the base ladders; and
a set of elongate sway braces which are each equipped at the longitudinal ends thereof with a clamp which is configured to be mounted on one of the rungs of one of the base ladders by engaging around one of the rungs,
wherein the cross-members and the sway braces are configured such that one of the cross-members can be mounted on the upper rung of a first of the base ladders and on the upper rung of a second of the base ladders, while one of the sway braces is mounted on the upper rung of the first of the base ladders and on the lower rung of the second of the base ladders.
